(19) United States
(12) Patent Application Publication
(10) Pub. No.: US 2016/0381660 A1
(43) Pub. Date: Dec. 29, 2016

(54) MOBILE DEVICE WITH USER INDICATION OF PENDING RADIO COVERAGE LOSS

(71) Applicant: Motorola Mobility LLC, Chicago, IL (US)

(72) Inventors: Himanshu Mittal, Fremont, CA (US); Shyam Narayan, Santa Clara, CA (US)

(21) Appl. No.: 14/749,846

(22) Filed: Jun. 25, 2015

(51) Int. Cl. H04W 68/04; H04W 24/08; H04W 4/02

(52) U.S. Cl. CPC H04W 68/04; H04W 4/026; H04W 24/08; H04W 4/028; H04W 84/12

(57) ABSTRACT

A mobile device includes wireless local area network (WLAN) baseband hardware, a wide area network (WAN) transceiver, location hardware, and a processor. The processor is operatively coupled to the WLAN baseband hardware, the WAN transceiver and the location hardware. The processor is configured to determine that the mobile device is moving away from a radio coverage area of a WLAN access point and to provide a mobile device user with notification of pending loss of radio coverage. The processor may also provide instructions to the user of a direction to move in so as to maintain WLAN radio coverage. The instructions may be provided visually by displaying an arrow on the display, or vocally using text-to-voice audio output.

### FIELD OF THE DISCLOSURE

The present disclosure relates generally to wireless communication devices and more particularly to wireless communication devices that support one or more wireless technologies and to the detection of radio coverage for one or more of the wireless technologies.

### BACKGROUND

Current wireless communications devices, also referred to a “mobile devices,” include two or more wireless technologies such that a mobile device may communicate using various wide area networks (WANs) as well as wireless local area networks (WLANs). Depending on many circumstances such as, but not limited to, available radio coverage, network subscription costs such as per minute charges, user preferences, available network services, etc., a mobile device with a network connection may be handed over from one network to another network during the network connection. A network connection may be related to a data transaction (uploading, downloading, streaming media, etc.) or a voice connection such as voice-over-Internet-Protocol (VoIP) or a cellular (WAN) trunked type voice connection that are utilized for wireless telephone calls.

Mobile device handovers usually occur without the user being aware that any change in coverage has taken place, with the possible exception of some network indicator that appears on the mobile device display, if the user happens to look at the indicator and become aware that a change in the connected network has occurred. In situations where a mobile device handover is not possible, which can occur due to any number of reasons, a network connection may be dropped due to loss of radio coverage. In that case, the only indicator the user will have is the loss of connection or dropped telephone call and the user will, at that point need to attempt to reestablish the network connection. Establishing a network connection with the previous network may no longer be possible if the user has exited the radio coverage area for the particular network.

### BRIEF DESCRIPTION OF THE DRAWINGS

FIG. 1 is a diagram of a mobile device engaged in a data or voice connection with a WLAN and moving toward a radio coverage boundary of the WLAN.

FIG. 2 is a diagram of a mobile device in accordance with an embodiment.

FIG. 3 is a flow chart of a process in a mobile device in accordance with the embodiments.

FIGS. 4A through 4D provide examples of messages that may be displayed on a mobile device display in accordance with various embodiments.

FIG. 5 is a flow chart of a process in a mobile device in accordance with an embodiment.

### DETAILED DESCRIPTION

The disclosed embodiments provide a mobile device user with an advance notification of pending radio coverage loss for a wireless local area network (WLAN) connection. As the user moves toward the boundary of WLAN radio coverage, the mobile device will provide the user with an advance notification by way of vibrating, an audio alert, and/or a message box shown on the mobile device display. In some embodiments, the user may also be provided with a choice of whether to remain connected to the WLAN or whether to handover to a wide area network (WAN) by initiating handover procedures.

One aspect of the present disclosure is a mobile device that includes wireless local area network (WLAN) baseband hardware, a wide area network (WAN) transceiver, location hardware, and a processor. The processor is operatively coupled to the WLAN baseband hardware, the WAN transceiver, and the location hardware and is configured to determine that the mobile device is moving away from a radio coverage area of a WLAN access point. The processor provides a mobile device user with notification of pending loss of radio coverage in response to determining that the mobile device is moving outside of the WLAN radio coverage area.

The mobile device also includes a display, a vibrator unit, and a speaker with the processor further configured to provide the notification as at least one of a tactile notification by vibration of the vibrator unit, an audible alert using the speaker, or a visual alert message displayed on the display. In some embodiments, the processor is further configured to provide text-to-voice output to the speaker as the audible alert including verbal instructions to inform a mobile device user a direction to move in order to maintain WLAN radio coverage.

In one embodiment, the processor is further configured to display an arrow on the display that points toward a direction of WLAN radio coverage. The mobile device may include a gyroscope and accelerometer, or an accelerometer and magnetometer, that are operatively coupled to the processor. The processor may be further configured to determine the mobile device orientation using data from the gyroscope and accelerometer (or from an accelerometer and magnetometer); determine the mobile device location using location information from the location hardware; determine that WLAN radio coverage is degrading using connection information from the WLAN baseband hardware and a direction of movement using the location information; and determine the direction of the arrow on the display using the mobile device orientation, location and direction of movement.

In some embodiments, the mobile device processor may be further configured to display a graphical user interface (GUI) on the display that provides a selectable option to handover a WLAN connection to a WAN connection or maintain a WLAN connection; and display the arrow on the display in response to user selection input that selects the selectable option to maintain the WLAN connection.

Another aspect of the present disclosure is a method of operating a mobile device. The method includes determining that the mobile device is moving away from a radio coverage area of a WLAN access point; and providing a mobile device user with notification of pending loss of radio coverage. The notification may be a tactile notification by vibration of a vibrator unit, an audible alert using a speaker, or a visual alert message displayed on a display. The method of operation may also include providing text-to-voice output to the speaker as the audible alert including verbal instructions to inform a mobile device user of a direction to move in order to maintain WLAN radio coverage.

In some embodiments, the method of operation includes displaying an arrow on the display, where the arrow points toward a direction of WLAN radio coverage. The method may further include determining the mobile device orientation using data from a gyroscope and an accelerometer, or an accelerometer and magnetometer; determining the mobile device location using location information from location hardware; determining that WLAN radio coverage is degrading using connection information from WLAN baseband hardware and a direction of movement using the location information; and determining the direction of the arrow on the display using the mobile device orientation, location and direction of movement.

In some embodiments, the method may include displaying a graphical user interface (GUI) on the display that provides a selectable option to handover a WLAN connection to a WAN connection or maintain a WLAN connection; and displaying the arrow on the display in response to user selection input that selects the selectable option to maintain the WLAN connection.

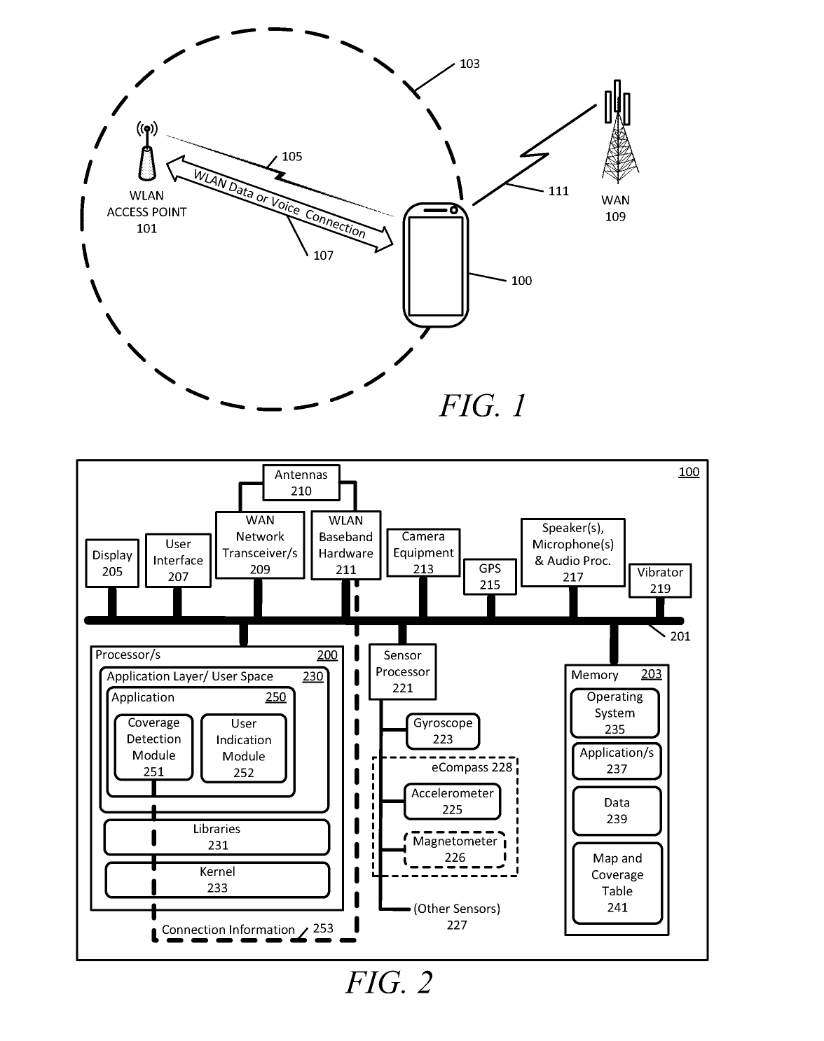

Turning now to the drawings, FIG. 1 illustrates a diagram of a mobile device 100 engaged in a WLAN data or voice connection 107 with a WLAN access point 101 as the mobile device 100 user is moving toward a boundary of the WLAN radio coverage area 103. The mobile device 100 connects with the WLAN access point 101 using a WLAN wireless link 105 to support a WLAN data or voice connection 107. The WLAN access point 101 has a certain radio coverage area 103 which is depicted in FIG. 1 as a circle for simplicity of explanation. However it is to be understood that the radio coverage area 103 of the WLAN access point 101 is not circular and does not have any predetermined geometry which is understood by those of ordinary skill.

The mobile device 100 may also connect with the WAN 109 using WAN wireless link 111. As is known to those of ordinary skill, as the mobile device 100 moves outside of the radio coverage area 103 the mobile device 100 may handover a WLAN connection to a WAN connection with the WAN 109 based on various network handover criteria, user preferences or both. In accordance with the embodiments, the user of mobile device 100 will be given the choice as to whether to handover the WLAN data or voice connection 107 to the WAN 109 or to maintain the WLAN data or voice connection 107 by remaining within the radio coverage area 103. This is accomplished in the various embodiments by providing the user of mobile device 100 with advance notification when the user begins to move toward the boundary of the radio coverage area 103 when connection information indicates that loss of the WLAN data or voice connection 107 is imminent. The mobile device 100 displays instructions that inform the user of which direction to move such that the WLAN data or voice connection 107 may be maintained if the user wishes to do so.

Further details of an example embodiment of the mobile device 100 are provided in FIG. 2. The mobile device 100 includes one or more processors 200, memory 203, a display 205, user interface 207, one or more wide area network transceivers 209 (such as, but not limited to CDMA, UMTS, GSM, etc.), WLAN baseband hardware 211 (which includes WLAN transceivers), one or more antennas 210, camera equipment 213, GPS hardware 215, speakers, microphones and audio processing 217, a vibrator unit 219, and a sensor processor 221. All of the components shown are operatively coupled to the one or more processors 200 by one or more internal communication buses 201. In some embodiments, the sensor processor 221 monitors sensor data from various sensors including a gyroscope 223 and an accelerometer 225 as well as other sensors 227. The gyroscope 223 and accelerometer 225 may be separate or may be combined into a single integrated unit. In some embodiments, the mobile device 100 may include an eCompass 228 that includes the accelerometer 225 and a magnetometer 226. The eCompass 228 may be present as an alternative to the gyroscope 223 and accelerometer 225 or may be a separate additional component of the mobile device 100. Speakers, microphones and audio processing 217 may include, among other things, at least one microphone, at least one speaker, signal amplification, analog-to-digital conversion/digital audio sampling, echo cancellation, etc., which may be applied to one or more microphones and/or one or more speakers of the mobile device 100.

The memory 203 is non-volatile and non-transitory and stores executable code for an operating system 235 that, when executed by the one or more processors 200, provides an application layer (or user space) 230, libraries 231 (also referred to herein as “application programming interfaces” or “APIs”) and a kernel 233. The memory 203 also stores executable code for various applications 237, data 239 and a map and coverage table 241 in some embodiments. The memory 203 may be operatively coupled to the one or more processors 200 via the internal communications buses 201 as shown, may be integrated with the one or more processors 200, or may be some combination of operatively coupled memory and integrated memory.

The one or more processors 200 are operative to launch and execute the applications 237 including an application 250 in accordance with an embodiment. The example application 250 may include a coverage detection module 251 and a user indication module 252. However it is to be understood that the application 250 can be implemented in other ways that are contemplated by the present disclosure and that the example shown in FIG. 2 is only one possible implementation. For example the coverage detection module 251 and the user indication module 252 may be separate applications or components or may be integrated together in some embodiments, etc.

The coverage detection module 251 is operatively coupled to the WLAN baseband hardware 211 and is operative to obtain measurements and parameters for the WLAN connection as connection information 253. The user indication module 252 is operative to control the display 205 to display message boxes and other information to the user in response to pending loss of coverage detected by the coverage detection module 251. The user indication module 252 is operative to control the vibrator unit 219 and cause it to vibrate and can cause the one or more speakers to produce and audible alert such a predetermined tone, voice warning message, beep, etc. The user indication module 252 may send control signals or commands over operative coupling that may be implemented via hardware connectivity such as internal communication buses 201 etc. in some embodiments and by using appropriate APIs (libraries 231) in embodiments where one or more components are implemented as software. The user indication module 252 may provide user indications using vibration, sound, displaying a message or by any combination of those approaches.

Obtaining and evaluating WLAN connection information 253 is handled by the coverage detection module 251 which can communicate with the WLAN baseband hardware 211 over the internal communication buses 201. In some embodiments, when the application 250 is launched, coverage detection module 251 may run as a background application and may wait until connection information 253 is received from the WLAN baseband hardware 211 after a WLAN connection has been established. The application 250 may also access the GPS hardware 215 to obtain location information in some embodiments. The location information may be used to determine the direction in which the mobile device 100 user is traveling with respect to radio coverage provided by a connected WLAN access point.

In the example of FIG. 2, the application 250, coverage detection module 251 or user indication module 252 are shown implemented as executable instructions executed by the one or more processors 200 that configure the one or more processors 200 to perform the methods of operation according to the embodiments. However, it is to be understood that either of these components or may be implemented as hardware, or as a combination of hardware and software/firmware. In embodiments in which one or more of these components is implemented as software, or partially in software/firmware, the executable instructions may be stored in the operatively coupled, non-volatile, non-transitory memory 203, that may be accessed by the one or more processors 200 as needed.

Therefore, it is to be understood that any of the above described example components in the example mobile device 100 may be implemented as software (i.e. executable instructions or executable code) or firmware (or a combination of software and firmware) executing on one or more processors, or using ASICs (application-specific-integrated-circuits), DSPs (digital signal processors), hardwired circuitry (logic circuitry), state machines, FPGAs (field programmable gate arrays) or combinations thereof. Therefore the mobile device 100 illustrated in FIG. 2 and described herein provides just one example embodiment and is not to be construed as a limitation on the various other possible implementations that may be used in accordance with the various embodiments.

As further examples, the coverage detection module 251 and/or user indication module 252 may be a single component or may be implemented as any combination of DSPs, ASICs, FPGAs, CPUs running executable instructions, hardwired circuitry, state machines, etc., without limitation. Therefore, as one example embodiment, coverage detection module 251 and user indication module 252 may be integrated together and may be implemented using an ASIC or an FPGA that may be operatively coupled to the one or more processors 200. These example embodiments and other embodiments are contemplated by the present disclosure.

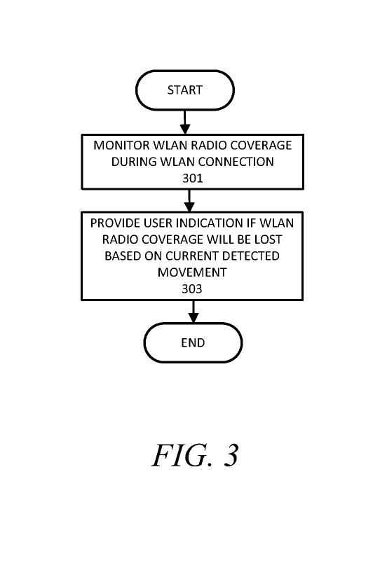

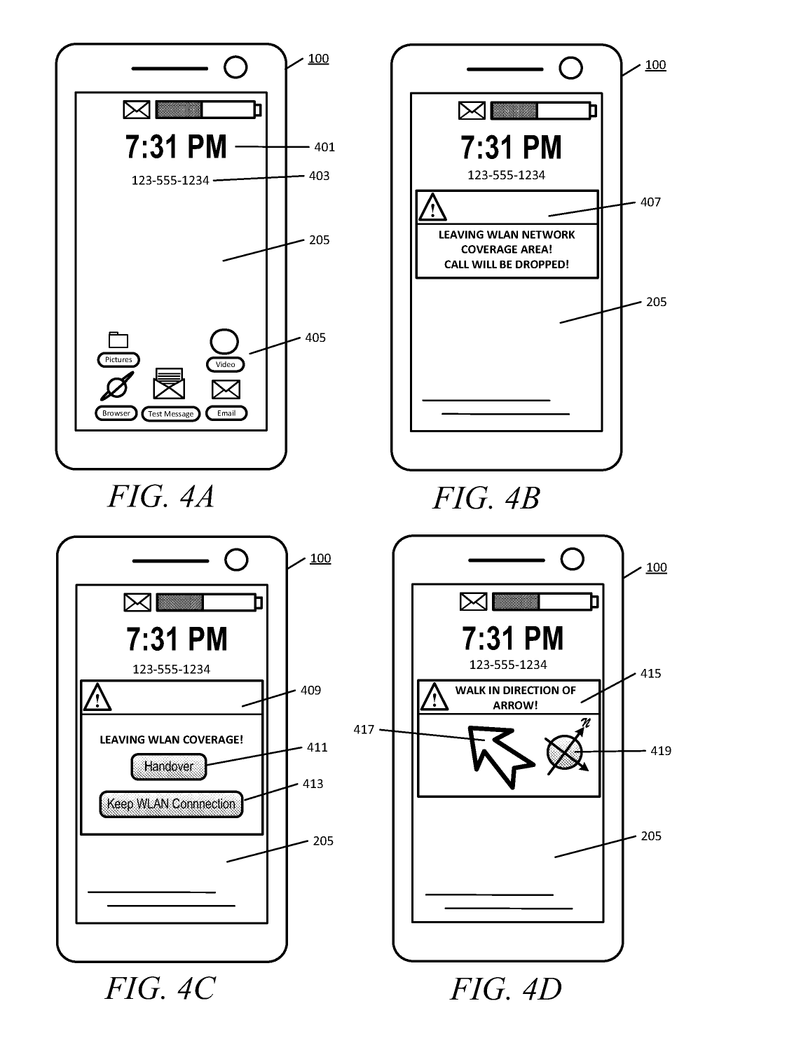

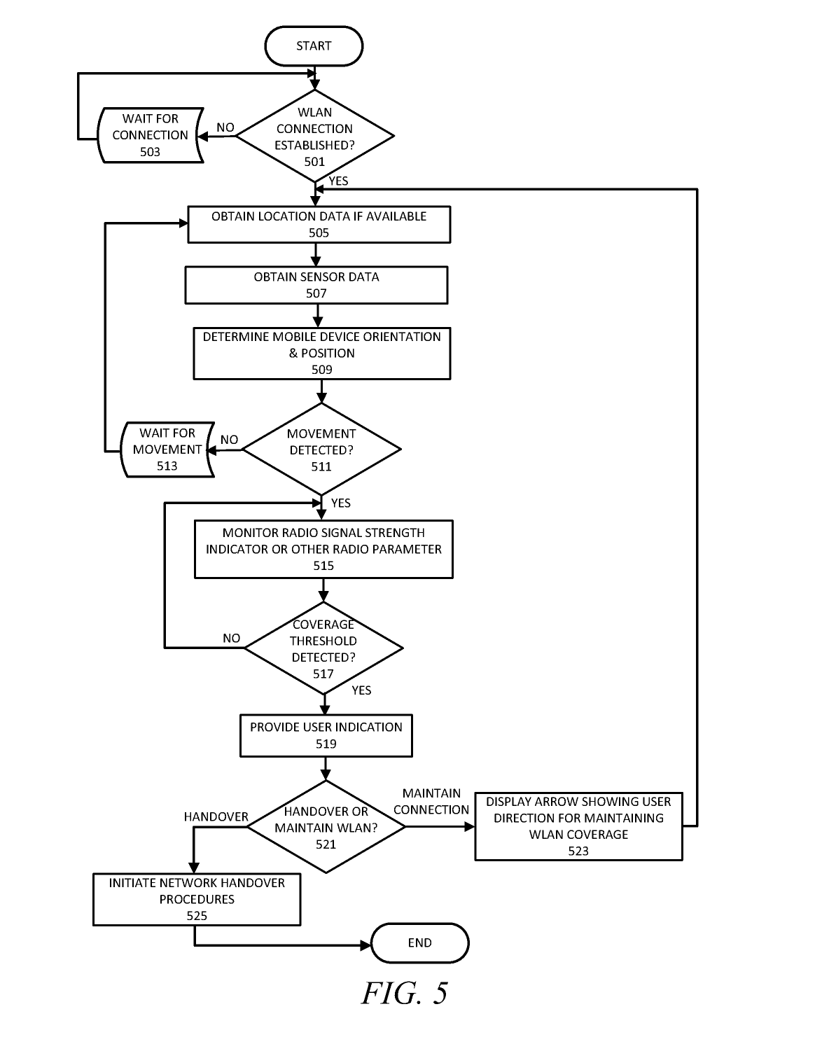

The various operations of the example mobile device 100 shown in FIG. 2 are best understood in conjunction with the flowcharts of FIG. 3 and FIG. 5 and the diagrams of FIGS. 4A through 4D. Turning to FIG. 3, in operation block 301, the coverage detection module 251 monitors connection information 253 received from the WLAN baseband hardware 211. In operation block 303, if the coverage detection module 251 determines that the user is moving outside of a WLAN radio coverage area, the user indication module 252 will provide an indication to the user of the pending loss of WLAN radio coverage. The indication may be vibration of the mobile device 100, an audible indication, a displayed message, or a combination of these alerts.

Turning to FIG. 4A, an example view of the mobile device 100 display during normal operation is shown. The display 205 provides a graphical user interface (GUI) and may include touchscreen capability in some embodiments. The display 205 may show various visual indications 401 that may include, among other things, a clock (i.e. time of day indication), an envelope icon indicating an email or text message received, and a battery level indicator. The battery level indicator may only be displayed when the battery charge is reduced to a certain predetermined level and therefore may not always be present. The envelope icon will only be present if an unread message has been received, etc. Some other icons may also be present such as a “missed call” icon, or an icon for unlocking the mobile device, or some other icon. If the mobile device 100 is engaged in a telephone call, a phone number 403 may also be displayed while the call is connected. Various application icons 405 may also be displayed.

In FIG. 4B, if the mobile device 100 has an active WLAN connection such as during a phone call or data connection, and if the user begins to move away from the radio coverage area of the WLAN access point, a notification such as message box 407 may be displayed that informs the user of the pending loss of connection. In one embodiment, the message box 407 is a pre-created graphic object that is stored in memory 203. The message box 407 may be a stand-alone notification, or may be accompanied by an audio tone sent to the speakers of the mobile device 100, or by a tactile warning by causing the vibrator unit 219 to vibrate.

In another example shown in FIG. 4C, a message box 409 may be displayed that asks the user whether they want to handover the current WLAN connection to a WAN or maintain the WLAN connection. More specifically, the GUI provides a selectable option on the display for which the user may provide selection input and select one of the options. In the example shown in FIG. 4C, the user may provide their selection input to the GUI by selecting a “handover” button 411 or a “keep WLAN connection” button 413. If the user selects the handover button 411 the mobile device 100 will initiate handover procedures with the WAN network and will proceed to handover the connection. However if the use selects the “keep WLAN connection” button 413, the mobile device 100 will display another view such as message box 415 or some equivalent as depicted in FIG. 4D.

The example message box 415 includes an arrow 417 which points in the direction that the user should move in order to maintain the WLAN connection, a compass 419 which provides a reference direction, and a text instruction portion that instructs the user to move in the direction of the arrow 417 so as to maintain WLAN radio coverage and thus maintain the WLAN connection.

It is to be understood that the visual indications shown in FIG. 4B through 4D are only examples and other formats may be used to instruct the user to move in the direction of radio coverage. For example, text instructions may be displayed that instruct the user to, for example, take three steps to the right and one step back or some other type of instructions, etc. In another embodiment, the text instructions may be read to the user as an audible notification using text-to-voice such that the user may follow the vocal text-to-voice instructions. The user indication module 252 may include a text-to-voice feature or may call a text-to-voice application from applications 237 using an appropriate API from libraries 231.

Turning to the flowchart of FIG. 5, in decision block 501 the processor 200 waits to see if a WLAN connection is established. If not, the processor 200 waits for the WLAN connection to be established as shown in operation block 503 and continues to monitor the status. If a WLAN connection is established in decision block 501, then in operation block 505 the processor 200 may proceed to obtain location data is available. The processor 200 may obtain the location data from the GPS hardware 215. In operation block 507, the processor 200 may also obtain sensor data from the sensor processor 221. The sensor data may be obtained from the gyroscope 223, the accelerometer 225 and from other sensors 227. The location information and sensor data is used to determine when the mobile device 100 is moving and its direction. In operation block 509, the processor 200 may initially determine the mobile device 100 orientation and position. In other words, the processor 200 may determine whether the top of the mobile device 100 is oriented horizontally or vertically with respect to the ground and how the mobile device 100 is oriented with respect to cardinal directions North, South, East and West.

This is accomplished using the sensor data obtained in operation block 507, and the location data obtained in operation block 505. It is to be understood that the processor 200 may monitor and obtain updates of the location data in operation block 505 and updates of the sensor data obtained in operation block 507 such that the processor 200 may determine when changes have occurred.

Therefore, in decision block 511, the processor 200 may determine whether movement is detected. If no movement is detected, then the processor 200 waits for movement in operation block 513 and continues to monitor the location and sensor data as shown. If movement is detected in decision block 511, then in operation block 515, the processor 200 will monitor connection information 253 from the WLAN baseband hardware 211. The connection information 253 may include any useful information reported or obtained by the WLAN baseband hardware 211 that may be used for determining the status of the WLAN connection. As such, the connection information 253 may include, but is not limited to, radio-signal-strength-indicator (RSSI) values, latency, jitter, packet loss, SINR (signal-to-noise and interference ratio), QOS (quality-of-service), etc.

For example, the processor 200 may monitor RSSI, jitter, delay, or some other radio parameter that may be used to determine when a WLAN data or voice connection 107 is degrading such that the connection may be lost if the user continues to move in the current direction. Some threshold for the parameters may be predetermined for this purpose. Thus in decision block 517, the processor 200 may determine if some radio coverage threshold is detected as determined by analysis of the connection information 253. If not, then in operation block 515 the processor 200 will continue to monitor the RSSI and/or other parameters. If the radio coverage threshold is detected in decision block 517, then in operation block 519 the processor 200 may provide the user an indication of pending radio coverage loss. For example, the processor 200 may display the message box 407 or message box 409 to the user on the display 205.

In decision block 521, the user may decide whether to handover the WLAN connection or maintain the WLAN connection. This may be accomplished by the user selecting even either the “handover” button 411 or the “keep WLAN connection” button 413 illustrated in FIG. 5C. If the user selects the handover button 411 then, in operation block 525, the processor 200 will initiate network handover procedures such that the WLAN connection may be handed over to a WAN. The process then ends as shown.

However if the user selects the “keep WLAN connection” button 413 then, in operation block 523, the processor 200 may display an arrow 417 showing the user the direction for maintaining WLAN coverage and the process will loop back to operation block 505 and continue to monitor location and sensor data.

While various embodiments have been illustrated and described, it is to be understood that the invention is not so limited. Numerous modifications, changes, variations, substitutions and equivalents will occur to those skilled in the art without departing from the scope of the present invention as defined by the appended claims.

What is claimed is:

1. A mobile device, comprising:
wireless local area network (WLAN) baseband hardware;
a wide area network (WAN) transceiver;
location hardware; and
a processor, operatively coupled to the WLAN baseband hardware, the WAN transceiver and the location hardware, the processor configured to:
determine that the mobile device is moving away from a radio coverage area of a WLAN access point; and
provide a mobile device user with notification of pending loss of radio coverage.

2. The mobile device of claim 1, further comprising:
a display, operatively coupled to the processor;
a vibrator unit operatively coupled to the processor;
a speaker operatively coupled to the processor; and
wherein the processor is further configured to:
provide the notification as at least one of a tactile notification by vibration of the vibrator unit, an audible alert using the speaker, or a visual alert message displayed on the display.

3. The mobile device of claim 2, wherein the processor is further configured to:
provide text-to-voice output to the speaker as the audible alert, that includes verbal instructions to inform a mobile device user a direction to move in order to maintain WLAN radio coverage.

4. The mobile device of claim 2, wherein the processor is further configured to:
display an arrow on the display, the arrow pointing toward a direction of WLAN radio coverage.

5. The mobile device of claim 4, further comprising:
a gyroscope and accelerometer, operatively coupled to the processor; and
wherein the processor is further configured to:
determine the mobile device orientation using data from the gyroscope and accelerometer;
determine the mobile device location using location information from the location hardware;
determine that WLAN radio coverage is degrading using connection information from the WLAN baseband hardware and a direction of movement using the location information; and
determine the direction of the arrow on the display using the mobile device orientation, location and direction of movement.

6. The mobile device of claim 4, wherein the processor is further configured to:
display a graphical user interface (GUI) on the display that provides a selectable option to handover a WLAN connection to a WAN connection or maintain a WLAN connection; and
display the arrow on the display in response to user selection input that selects the selectable option to maintain the WLAN connection.

7. The mobile device of claim 6, wherein the processor is further configured to:
display the graphical user interface (GUI) on the display wherein the selectable option to handover a WLAN connection is a first selectable GUI button and the selectable option to maintain a WLAN connection is a second selectable GUI button.

8. The mobile device of claim 7, wherein the processor is further configured to:
display the arrow on the display in response to user selection input that selects the second selectable GUI button.

9. The mobile device of claim 5, wherein the connection information comprises at least one of: radio-signal-strength-indicator (RSSI) values, latency data, jitter data, packet loss, SINR (signal-to-noise and interference ratio), or QOS (quality-of-service) values related to a WLAN connection.

10. A method of operating a mobile device, the method comprising:
determining that the mobile device is moving away from a radio coverage area of a WLAN access point; and
providing a mobile device user with notification of pending loss of radio coverage.

11. The method of claim 10, wherein providing the notification further comprises:
providing at least one of a tactile notification by vibration of a vibrator unit, an audible alert using a speaker, or a visual alert message displayed on a display.

12. The method of claim 11, further comprising:
providing text-to-voice output to the speaker as the audible alert, that includes verbal instructions to inform a mobile device user a direction to move in order to maintain WLAN radio coverage.

13. The method of claim 11, further comprising:
displaying an arrow on the display, the arrow pointing toward a direction of WLAN radio coverage.

14. The method of claim 13, further comprising
determining the mobile device orientation using data from a gyroscope and an accelerometer;
determining the mobile device location using location information from location hardware;
determining that WLAN radio coverage is degrading using connection information from WLAN baseband hardware and a direction of movement using the location information; and
determining the direction of the arrow on the display using the mobile device orientation, location and direction of movement.

15. The method of claim 13, further comprising
displaying a graphical user interface (GUI) on the display that provides a selectable option to handover a WLAN connection to a WAN connection or maintain a WLAN connection; and
displaying the arrow on the display in response to user selection input that selects the selectable option to maintain the WLAN connection.

16. The method of claim 15, further comprising
display the graphical user interface (GUI) on the display wherein the selectable option to handover a WLAN connection is a first selectable GUI button and the selectable option to maintain a WLAN connection is a second selectable GUI button.

17. The method of claim 16, further comprising
displaying the arrow on the display in response to user selection input that selects the second selectable GUI button.

18. The mobile device of claim 14, wherein determining that WLAN radio coverage is degrading using connection information from WLAN baseband hardware comprises:
obtaining as the connection information at least one of: radio-signal-strength-indicator (RSSI) values, latency data, jitter data, packet loss, SINR (signal-to-noise and interference ratio), or QOS (quality-of-service) values related to a WLAN connection.
